(19) United States
(12) Patent Application Publication
(10) Pub. No.: US 2009/0081900 A1
(43) Pub. Date: Mar. 26, 2009

(54) Electric connector

(75) Inventors: Hong Chuan Tay, Singapore (SG); Sen Ming Lee, Singapore (SG)

Correspondence Address: RADER FISHMAN & GRAUER PLLC, LION BUILDING, 1233 20TH STREET N.W., SUITE 501, WASHINGTON, DC, 20036, US

(73) Assignee: MEA Technologies Pte. Ltd., Singapore (SG)

(21) Appl. No.: 12/230,969

(22) Filed: Sep. 9, 2008

(30) Foreign Application Priority Data
Sep. 21, 2007 (SG) 200708379-3

(51) Int. Cl. H01R 13/627

(52) U.S. Cl. 439/358

(57) ABSTRACT

An electric connector 1 has an integrally-molded connector housing 2 and contact terminals 3 installed therein. The connector housing 2 has a supporting base 2A with front and rear surfaces, a pair of arm parts 2C, 2C extending outward, with a particular spacing therebetween, from the rear surface of the supporting base 2A, and a terminal attachment part 2B to which the contact terminals 3 are installed and which extends outward from the front surface of the supporting base 2A. The contact terminals 3 are installed to the terminal attachment part 2B. At each tip of the pair of arm parts 2C, 2C there is provided a latching parts 2D₁, 2D₁ with release finger which is detachably attached to a printed circuit board 5. An electric connector having an attaching means enabling simple installation to and removal from a circuit board is provided.

### TECHNICAL FIELD

The present invention relates to an electric connector, more particularly to an electric connector that has an attaching means enabling installation and-removal in a simple manner to and from a printed circuit board, and can be connected especially well to a plug connected to a USB cable.

### BACKGROUND ART

Computers and the like electronic equipment are provided with electric connectors at their input/output (I/O) ports. Such connectors are constituted of an internal connector that is installed to a circuit board, and an external connector that is connected to an external cable. Usually a receptacle connector is used for the internal connector, and a plug connector is used for the external connector. A typical example of the receptacle connector is set forth in JP-A-2003-347685 issued in Japan. FIG. 10 illustrates the connector set forth in this Japanese Patent Application Publication, FIG. 10A being a top view of the connector and FIG. 10B being a rear view thereof.

A circuit module 60 is equipped with a USB connector 61 constituting a circuit component, and with a printed circuit board 62 to which the USB connector 61 is mounted. The USB connector 61 has a connector body 63 and a metallic shield cover 64 that covers the connector body 63.

The connector body 63 has an insertion mouth 65 into which the plug of a. USB cable is removably inserted, and multiple pin terminals 66. The insertion mouth 65 is formed at one end of the connector body 63. The pin terminals 66 are located at the opposite end to the insertion mouth 65, and are projected to the exterior of the connector body 63. The shield cover 64 has a top plate 67 that covers the connector body 63 from above, a bottom plate 68 that covers the connector body 63 from below, and left and right lateral plates 69a, 69b that cover the connector body 63 laterally. Further, the shield cover 64 takes the form of a flattened box having four sharply right-angled corners 70, these corners 70 being located on the peripheral surface of the USB connector 61. The lateral plates 69a, 69b of the shield cover 64 each have a conducting strip 71. The conducting strips 71 jut out to the sides of the shield cover 64 and are positioned on the printed circuit board 62. The printed circuit board 62 has an oblong substrate 72. The substrate 72 is formed by stacking insulating layers and conducting layers alternately, and applying pressure. The substrate 72 has a cut portion 73 which is formed by performing cutting or punch processing on the substrate 72. The cut portion 73 constitutes a recess that is formed so as to be open at the outer edge of the substrate 72 and is of a size such that the USB connector 61 will enter thereinto. Also, a USB connector such as mentioned here is disclosed in JP-A-11-260489.

USB connectors of this kind are fixed to a printed circuit board by means of solder connections, and therefore, once fixed to the board, cannot be removed therefrom unless the solder is melted. This means that repair or replacement, etc., of the connector is not a simple matter. Although in recent times, out of consideration for environmental problems, practices have arisen such as the use of solder that does not contain lead, and of what are termed “solderless” connections that do not use solder, these practices have the implicit issue of not being able to address the foregoing problems with this type of connector. Accordingly, in order to resolve such issues, connectors that can be connected to circuit boards without using solder have been developed. Examples of such connectors are those disclosed in JP-A-11-242971 and JP-A-7-245147 issued in Japan.

The USB connector disclosed in JP-A-2003-347685 is, as mentioned above, fixed to a circuit board by means of solder connections, and therefore, once fixed to the board, cannot be removed therefrom unless the solder is melted. This means that repair and replacement, etc., of this connector is not a simple matter. By contrast, connectors such as disclosed in JP-A-11-242971 and JP-A-7-245147 do not require soldering. Nevertheless, in order to remove connector housings thereof from the circuit board, one must be unfasten such from the board by using a tool or the like at the reverse surface of the board. Thus, removal thereof is not a simple matter either. Further, these connectors are not shielded, and therefore are susceptible to the effects of external noise.

### SUMMARY

An advantage of some aspects of the present invention is to provide an electric connector that has an attaching means enabling not only simple attachment to a board, but also simple removal therefrom.

Another advantage is to provide an electric connector that is shielded and suitable as a USB connector.

Further, another advantage is to provide an electric connector that has a low number of components and is simple to assemble, besides also being compact and low-cost.

According to an aspect of the present invention, an electric connector includes a contact terminal, and a connector housing in which the contact terminal is installed, and has the advantageous features that the connector housing has a supporting base with front and rear surfaces of a particular size, a pair of arm parts of a particular length that extend outward, with a particular spacing therebetween, from the two ends of either the front or the rear surface of the supporting base, and a terminal attachment part to which the contact terminal is installed and which extends outward from a central portion of the other surface, front or rear, of the supporting base. The contact terminal is installed to the terminal attachment part, at each tip of the pair of arm parts there is provided a latching part with release finger which is detachably attached to a board to which the connector is installed; and the whole connector housing is formed as one integral molding.

With the above aspect, the connector housing is provided with latching parts with release fingers, and by manipulating the release fingers, the connector can be installed to and removed from a circuit board in a simple manner. Also, the connector housing, being so configured that the latching parts with release fingers project from one surface of the supporting base, and the terminal attachment part from another surface, has therefore a simple structure, is easy to mold, and can be manufactured at low cost.

Preferably, the latching parts with release fingers may be formed with the release fingers extending from the tips of the arm parts in one direction orthogonal to the longitudinal direction of the arm parts, and likewise with latching pieces extending from the tips of the arm parts in the other direction orthogonal to the longitudinal direction of the arm parts.

With the above features, the latching parts with release fingers can be formed on the connector housing in a simple manner.

Also preferably, on the latching parts with release fingers, projections that will serve as rocking fulcrums will preferably be provided in the proximity of the boundary between the release fingers and the latching pieces.

With the above features, the projections serving as rocking fulcrums are provided in the proximity of the boundary between the release fingers and the latching pieces, so that when the pair of release fingers are brought closer together in order to remove the connector from the circuit board, the actuation motions of the latching pieces are centered on these projections, and thus the connector can be removed in a simple manner.

Preferably, the contact terminal may have a contacting portion at both ends, and may be so installed to the terminal attachment part that one contacting portion is positioned at the terminal attachment part and the other contacting portion is positioned beyond the supporting base, between the pair of arm parts.

With the above features, the contact terminal can be connected to the contacting portions of the circuit board without using solder.

Also, the terminal attachment part may preferably be covered by a shield cover that has a plug insertion mouth at one end.

With the above features, the terminal attachment part is covered by a shield cover with a plug insertion mouth at one end, and thereby the penetration of external noise will be prevented.

### BRIEF DESCRIPTION OF THE DRAWINGS

The invention is described with reference to the accompanying drawings, wherein like numerals refer to like elements.

FIG. 1 is an exploded perspective view of an electric connector in an embodiment of the present invention.

FIG. 2 illustrates the housing of the electric connector in FIG. 1, FIG. 2A being a perspective view thereof from one direction and FIG. 2B a perspective view thereof from another direction.

FIG. 3 illustrates the assembled electric connector, FIG. 3A being a top view thereof, FIG. 3B a front view, FIG. 3C a rear view and FIG. 3D a side view.

FIG. 4 explicates the installation of the electric connector to a printed circuit board, FIG. 4A being a front view of the connector, FIG. 4B a cross-sectional view along line IVB-IVB in FIG. 4A, and FIG. 4C a cross-sectional view corresponding to that in FIG. 4B but prior to installation to the printed circuit board.

FIG. 5 explicates a contact terminal, FIG. 5A being a side view of the contact terminal, and FIG. 5B a cross-sectional view of the contact terminal of FIG. 5A installed in the housing.

FIG. 6 is a perspective view of the printed circuit board and electric connector prior to installation.

FIG. 7 explicates the process of installing the electric connector to the printed circuit board, being a series of cross-sectional views along line VII-VII in FIG. 6.

FIG. 8 is a perspective view of the printed circuit board and electric connector midway through installation.

FIG. 9 explicates the process of removing the electric connector from the printed circuit board, being a series of cross-sectional views along line IX-IX in FIG. 8.

FIG. 10 illustrates a connector of the related art, FIG. 10A being a top view thereof and FIG. 10B being a rear view.

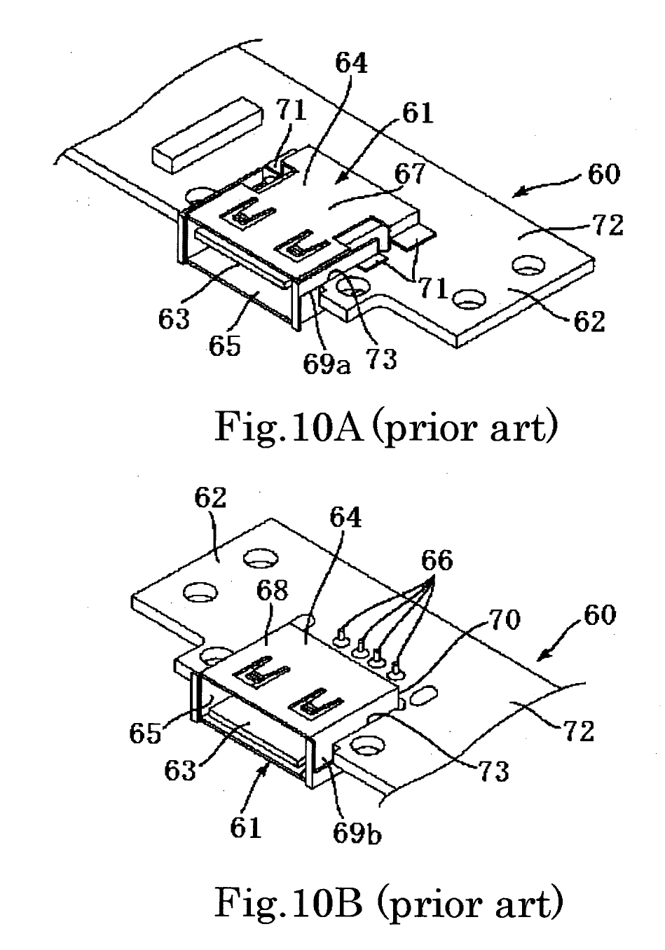

### DESCRIPTION OF EXEMPLARY EMBODIMENT

An exemplary embodiment of the present invention will now be described with reference to the accompanying drawings. It should be understood however that the following embodiment is intended by way of an example of an electric connector that realizes the technical concepts of the invention, not by way of limiting the invention to this particular electric connector. It will be obvious to those skilled in the art that the invention can equally well be adapted to yield various other embodiments without departing from the spirit and scope of the claims.

### First Embodiment

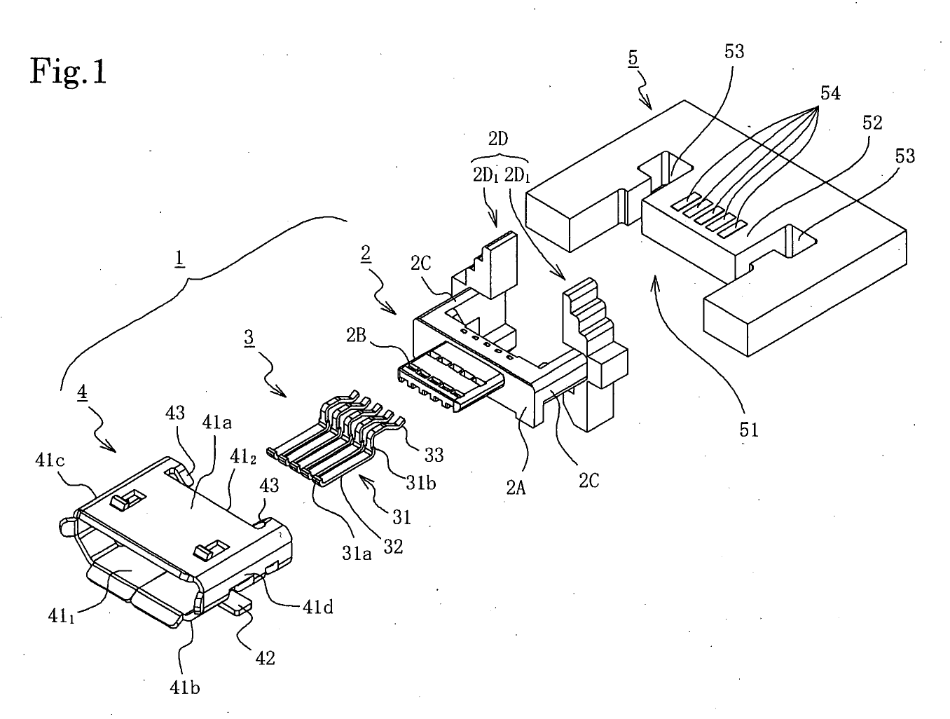

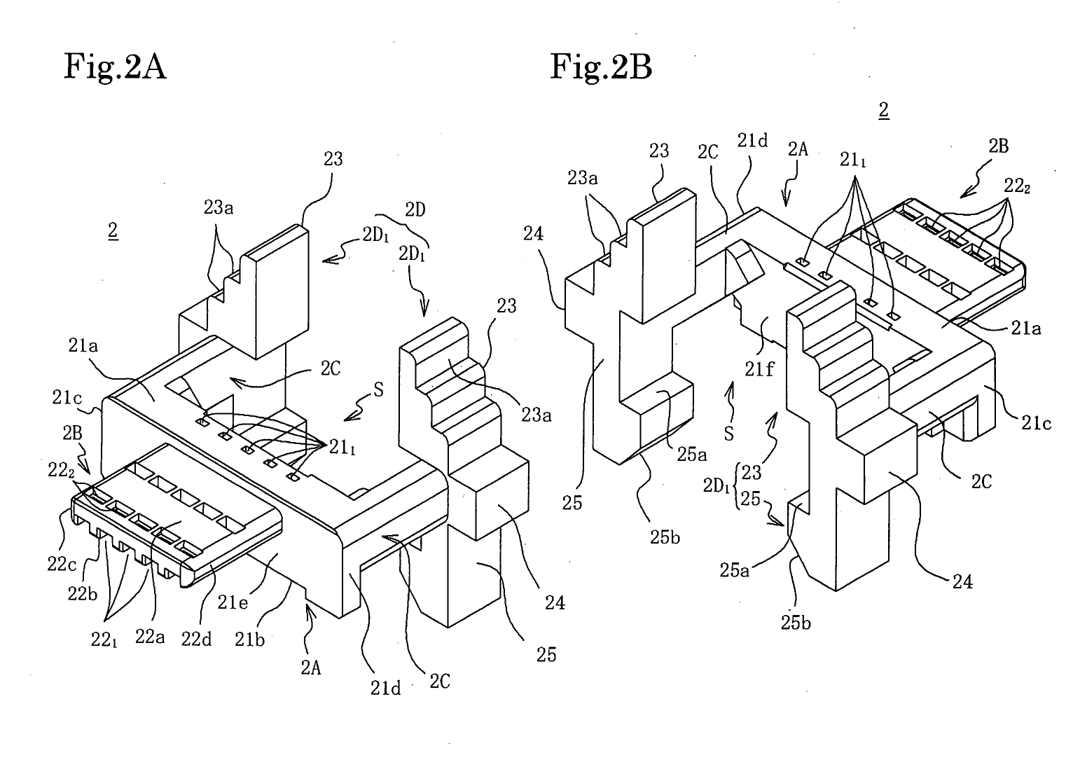

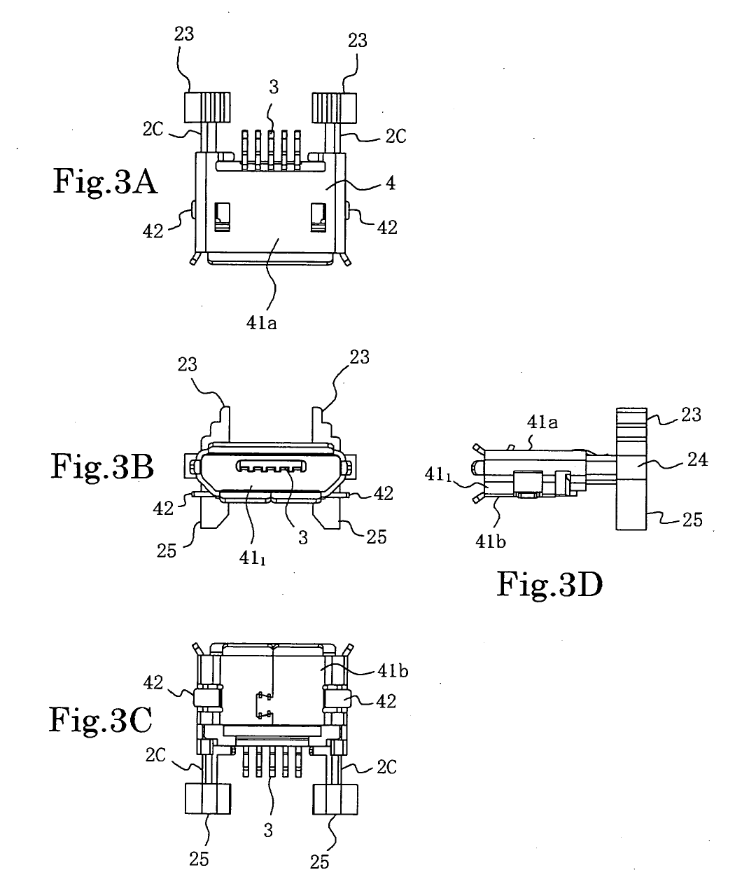

An electric connector in an embodiment of the present invention will be described with reference to FIGS. 1 to 5. FIG. 1 is an exploded perspective view of an electric connector in an embodiment of the invention, FIG. 2 illustrates the housing of the electric connector in FIG. 1, FIG. 2A being a perspective view thereof from one direction and FIG. 2B a perspective view thereof from another direction, and FIG. 3 illustrates the assembled electric connector, FIG. 3A being a top view thereof, FIG. 3B a front view, FIG. 3C a rear view and FIG. 3D a side view.

An electric connector 1 has multiple contact terminals 3, a connector housing 2 (hereinafter simply referred to as the “housing”) in which the contact terminals 3 are installed, and a shield cover 4 that covers the contact terminals 3 installed inside the housing 2. Also, the housing 2 is provided with a terminal attachment part 2B for attachment of the contact terminals 3, and a pair of latching parts 2D₁, 2D₁ with release fingers which are detachably attached to a printed circuit board 5. The structure of each of these members is described individually below.

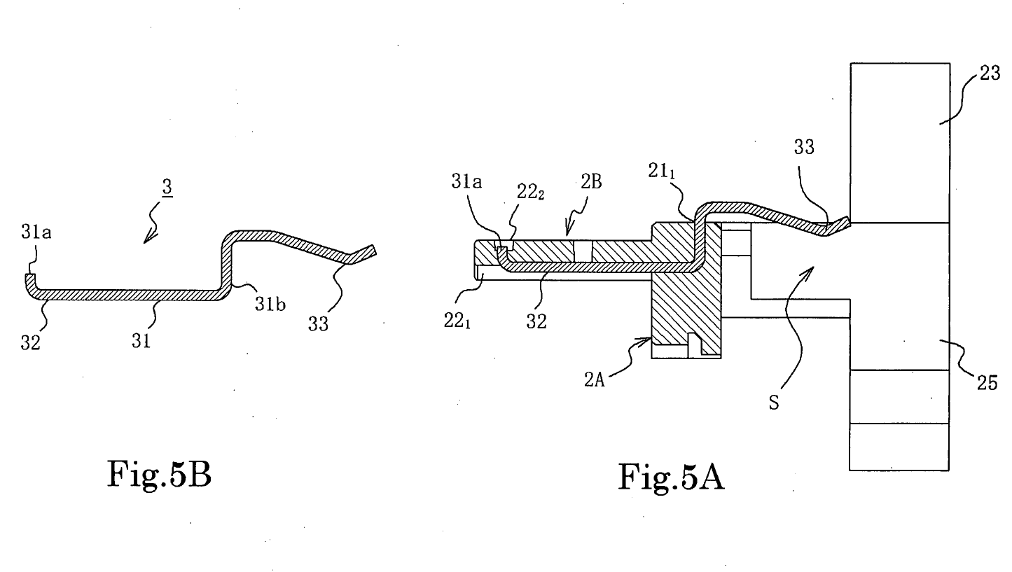

The multiple contact terminals 3 all have the same shape and are formed by bend-processing strip-form pieces of a plate material with good conductivity. As shown in FIGS. 1 and 5A, these contact terminals 3 are elongated strip-form pieces 31 provided with contacting portions 32, 33 at either end. Also, the strip-form piece 31 has a latching part 31a formed at one end, and is provided with a bend portion 31b midway along its length. Of the contacting portions 32, 33, the contacting portion 32 is connected to a plug (omitted from the drawings) and the other contacting portion 33 is connected to a contact 54 on the printed circuit board 5.

The housing 2 has, as shown in FIG. 2, a supporting base 2A located roughly in the center thereof, a terminal attachment part 2B to which the multiple contact terminals 3 are installed and which projects a particular distance outward from one side of the supporting base 2A, a pair of arm parts 2C, 2C that project a particular distance outward from the two longitudinal ends of the other side, and hand parts 2D, 2D provided on the tips of the arm parts 2C, 2C. Further, latching parts 2D₁, 2D₁ with release fingers are provided on the hand parts 2D, 2D. Also, the housing 2 is formed as a single integral molding of electrically insulative synthetic resin.

The supporting base 2A is formed as a plate-form body having particular width, length and thickness. Such plate-form body will be formed to the desired size according to the connector size. This supporting base 2A has top, bottom, left and right wall surfaces 21a, 21b, 21c, 21d, as well as front and rear wall surfaces 21e, 21f. In the top wall surface 21a there are formed multiple insertion holes 21₁ through which the bend portions 31b of the contact terminals 3 are inserted.

The terminal attachment part 2B is formed as a plate-form body having particular width, length and thickness. The size of such plate-form body will be determined according to the size of the connector to which the electric connector 1 is connected, and the number of contact terminals 3 installed therein. This terminal attachment part 2B has top, bottom, left and right wall surfaces 22a, 22b, 22c, 22d, and one edge thereof is integrally joined to the front wall surface 21e of the supporting base 2A. In the bottom wall surface 22b there are formed multiple flat-bottomed grooves 22₁ into which the contact terminals 3 are fitted. Also, toward the front of the terminal attachment part 2B there are formed latching holes 22₂ that penetrate from the top wall surface 22a through to the bottom wall surface 22b. The flat-bottomed grooves 22₁ communicate with the insertion holes 21₁ at one end, and at the other end communicate with the latching holes 22₂.

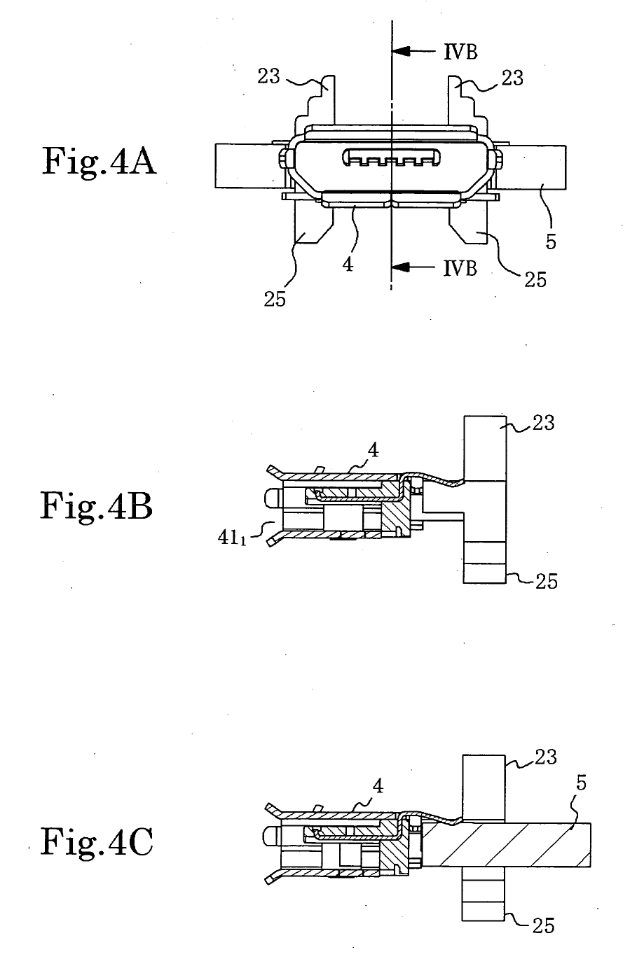

Next will be described, with reference to FIGS. 4 and 5, the attaching of the contact terminals 3. FIG. 4 explicates the installation of the electric connector to the printed circuit board, FIG. 4A being a front view of the connector, FIG. 4B a cross-sectional view along line IVB-IVB in FIG. 4A, and FIG. 4C a cross-sectional view corresponding to that in FIG. 4B but prior to installation to the printed circuit board. FIG. 5 explicates the contact terminal, FIG. 5A being a side view of the contact terminal, and FIG. 5B a cross-sectional view of the contact terminal of FIG. 5A installed in the housing.

The multiple contact terminals 3 are inserted into and fixed in the flat-bottomed grooves 22₁ in the terminal attachment part 2B. Such fixing operation is performed by inserting the strip-form pieces 31 of the contact terminals 3 into the flat-bottomed grooves 22₁, inserting the bend portions 31b through the insertion holes 21₁, and inserting the latching parts 31a into the latching holes 22₂ so as to latch thereto. Thereby, the contacting portions 32 at one end are positioned inside the flat-bottomed grooves 22₁, and the contacting portions 33 at the other end are projected into the space S between the pair of arm parts 2C, 2C.

The pair of arm parts 2C, 2C project outward, with a particular spacing therebetween, to a particular distance from the two longitudinal ends of the supporting base 2A. More precisely, each arm part 2C has a particular thickness, and projects almost perpendicularly from the rear wall surface 21f of the supporting base 2A. The portions where the arm parts 2C, 2C join with the supporting base 2A are made thick, and high mechanical strength is thereby imparted thereto. The arm parts 2C, 2C oppose each other, approximately in parallel, and a space S is formed therebetween. Into this space S, the protrusion 52 in the printed circuit board 5 is inserted. The ends of the pair of arm parts 2C, 2C, that is, the places that correspond to the “wrists” thereof, are provided with release fingers 23, 23 above and latching pieces 25, 25 below, which project perpendicularly, the former upward and the latter downward, relative to the wrist portions. On the outside of each wrist portion there are formed projections 24, 24 serving as rocking fulcrum.

The release fingers 23, 23 are formed as relatively long pieces having the same shape. Multiple step portions 23a, 23a are formed, stair-like, on the outside of each release finger 23, 23. Also, the spacing between the two release fingers 23, 23 is smaller than the width of the protrusion 52 in the printed circuit board 5. Thereby, when the electric connector 1 is installed to the printed circuit board 5, the inner bottom parts of the release fingers 23, 23 will rest on the top surface of the protrusion 52 in the printed circuit board 5, and good positioning will be effected. Also, since the release fingers 23, 23 are relatively long, it is easy to take hold thereof. Thus when one takes hold, with one's fingers, of the apexes of the release fingers 23, 23 and pushes them closer together, the latching pieces 25, 25 will open outward, with the projections 24, 24 serving as rocking fulcrums therefor.

The pair of latching pieces 25, 25 have the same shape. At the mutually opposed faces of the end portions of the latching pieces 25, 25 there are formed latching ledges 25a, 25a. Below the latching ledges 25a, 25a, at the tips, there are provided inclined portions 25b, 25b facilitating installation into the latching openings in the printed circuit board 5.

The shield cover 4 is fitted over the terminal attachment part 2B. As FIG. 1 shows, the shield cover 4 is constituted of a flattened tubular body, whose periphery is enclosed by top, bottom and lateral plates 41a to 41d, which has a through-hole in the interior, and which is formed by bend-processing of metal plate. Of the openings 41₁, 41₂ at the front and rear thereof, the rear opening 41₂ has outer dimensions of roughly the same size as the supporting base 2A, while the front opening 41₁ is of a size enabling insertion of a USB plug not shown in the drawings. Also, conductive pieces 42, 42 are formed in the lateral plates 41c, 41d. Further, the rear opening 41₂ is provided with attachment pieces 43, 43 at the rim thereof.

The electric connector 1 is assembled by installing the contact terminals 3 to the terminal attachment part 2B, placing the shield cover 4 over the terminal attachment part 2B, and making the attachment pieces 43, 43 of the shield cover latch to the arm parts 2C, 2C. Constituted of three components—the housing 2, contact terminals 3 and shield cover 4—which moreover are of simple shapes, this electric connector 1 is both simple to manufacture and simple to assemble.

In an edge of the printed circuit board 5 there is formed an attaching slot 51 for attachment of the electric connector 1. This attaching slot 51 has, in the interior thereof, which is of a particular size, a protrusion 52 of a size such as to be inserted onto the space S of the housing 2, and at the two sides of the protrusion 52, a pair of latching apertures 53, 53 into which the pair of latching pieces 25, 25 are inserted. On the obverse surface of the protrusion 52 there are provided multiple contacts 54, with which the contacting portions 33 of the contact terminals 3 contact. The latching apertures 53, 53 are of a size enabling insertion of the projections 24, 24 thereinto. After the latching pieces 25, 25 have been inserted through the latching apertures 53, 53, the latching ledges 25a, 25a latch onto the reverse face of the protrusion 52 in the printed circuit board 5.

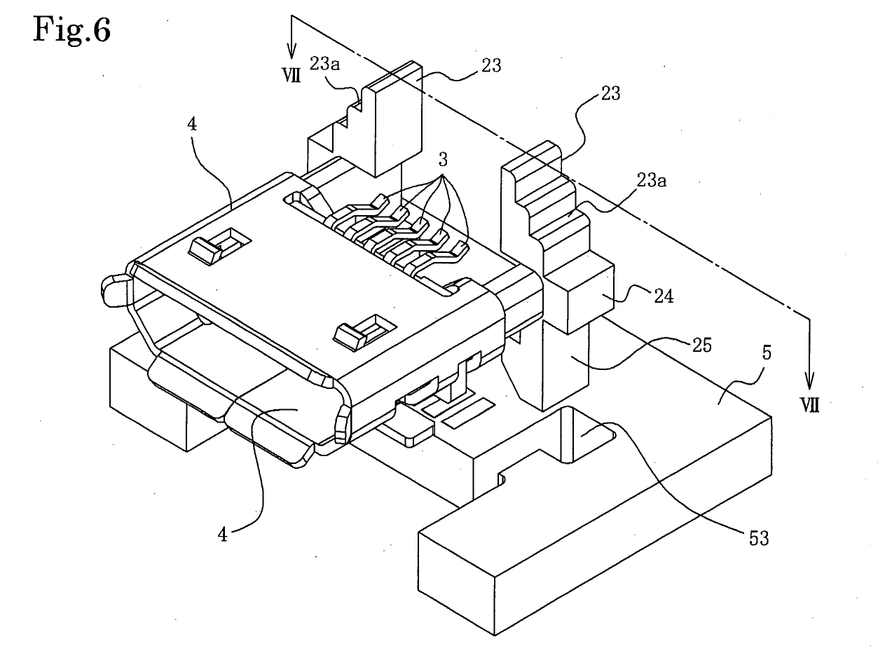

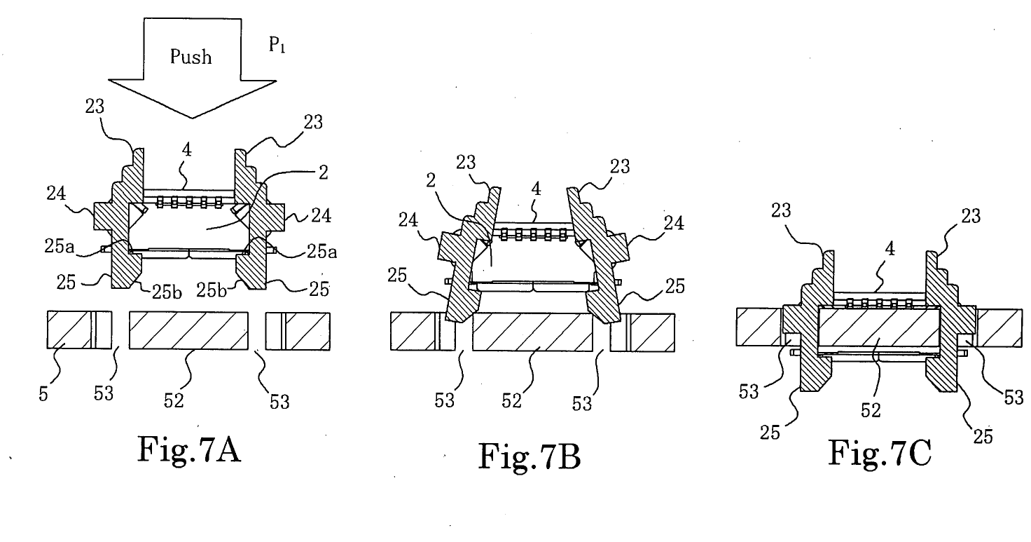

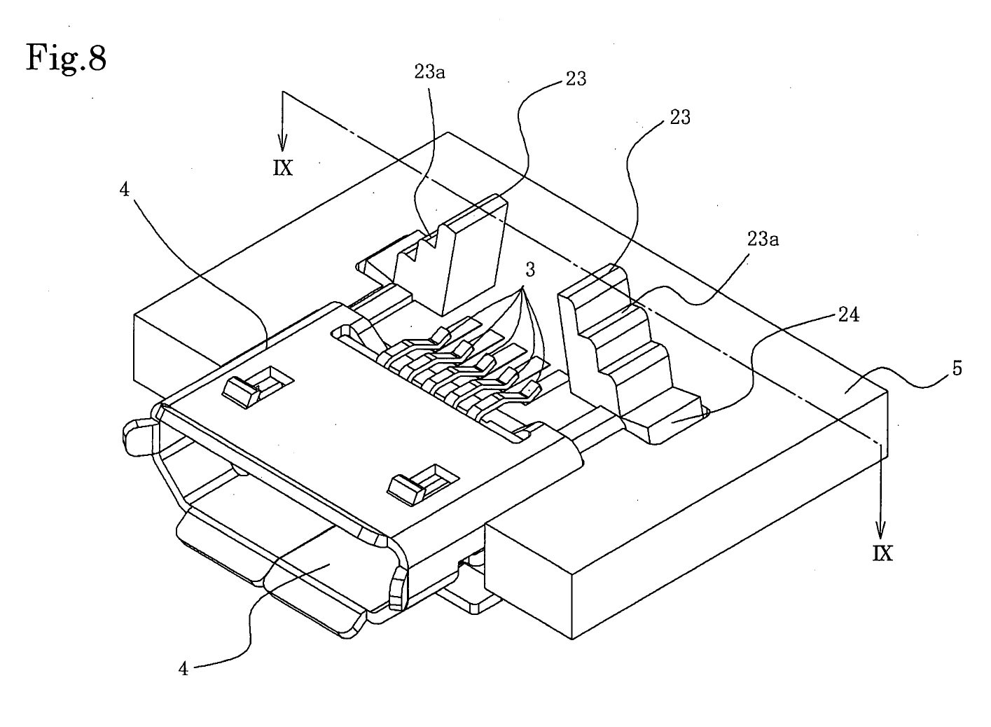

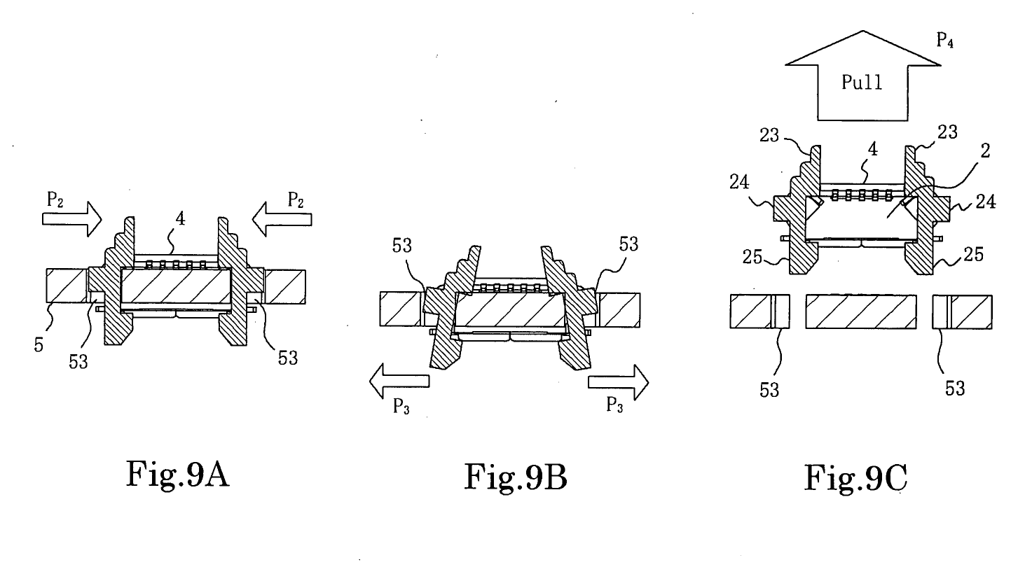

Next, installation and removal of the electric connector to/from the printed circuit board will be described with reference to FIGS. 6 to 9. FIG. 6 is a perspective view of the printed circuit board and electric connector prior to installation. FIG. 7 explicates the process of installing the electric connector to the printed circuit board, being a series of cross-sectional views along line VII-VII in FIG. 6, FIG. 8 is a perspective view of the printed circuit board and electric connector midway through installation, and FIG. 9 explicates the process of removing the electric connector from the printed circuit board, being a series of cross-sectional views along line IX-IX in FIG. 8.

To install the electric connector 1 to the printed circuit board 5, first of all, the electric connector 1 is moved to above the printed circuit board 5 so as to position the pair of latching pieces 25, 25 over the latching apertures 53, 53 in the printed circuit board 5, as shown in FIGS. 6 and 7. With such state, the electric connector 1 is made to descend from above by application of a particular push force P1, so that the tips of the latching pieces 25, 25 are inserted into the latching apertures 53, 53 (see FIG. 7A). When the tips of the latching pieces 25, 25 are inserted into the latching apertures 53, 53, the inclined portions 25b, 25b contact against the edges of the insides of the latching apertures 53, 53, and the latching parts 2D₁, 2D₁ with release fingers, are moved, against the resilience thereof, in a direction such that the tips of the latching pieces 25, 25 open outward away from each other (see FIG. 7B). When the electric connector 1 is pushed in further, the tips of the latching pieces 25, 25 are moved right through the latching apertures 53, 53, simultaneously with which, the projections 24, 24 are inserted inside the latching apertures 53, 53, and the latching parts 2D₁, 2D₁ with release fingers return to the former state (see FIG. 7C). Thereby, the latching ledges 25a, 25a of the latching pieces 25, 25 are latched onto the reverse surface of the printed circuit board 5, whereupon installation of the electric connector 1 to the printed circuit board 5 is complete. Thus, the electric connector can be installed in a simple manner, just by being pushed onto the printed circuit board 5. Also, this will effect electrical connection between the contacting portions 33 of the contact terminals 3 and the contacts 54 on the printed circuit board 5. Such connection will be effected without using solder.

To remove the electric connector 1 from the printed circuit board 5, one takes hold, with one's fingers, of the release fingers 23, 23 and applies push force P2 in directions such that the release fingers 23, 23 are brought closer together (see FIG. 9A). This results in a rocking motion of the latching parts 2D₁, 2D₁ with release fingers, with the projections 24, 24 as rocking fulcrums, and due to such rocking, the latching pieces 25, 25 move in the directions P3, P3, so that the latching ledges 25a, 25a thereof move clear of the reverse surface of the printed circuit board 5 (see FIG. 9B). With such state, when the release fingers 23, 23 are pulled upward, that is, in the direction P4, the latching pieces 25, 25 come out from the latching apertures 53, 53, so that the electric connector 1 is detached from the printed circuit board 5 (see FIG. 9C).

What is claimed is:

1. An electric connector comprising:
a contact terminal; and
a connector housing in which the contact terminal is installed;
the connector housing comprising:
a supporting base with front and rear surfaces of a particular size;
a pair of arm parts of a particular length that extend outward, with a particular spacing therebetween, from the two ends of either the front or the rear surface of the supporting base; and
a terminal attachment part to which the contact terminal is installed and which extends outward from a central portion of the other surface, front or rear, of the supporting base;
the contact terminal being installed to the terminal attachment part;
at each tip of the pair of arm parts there being provided a latching part with release finger which is detachably attached to a board to which the connector is installed; and
the whole connector housing being formed as one integral molding.

2. The electric connector according to claim 1, wherein the latching parts with release fingers are formed with the release fingers extending from the tips of the arm parts in one direction orthogonal to the longitudinal direction of the arm parts, and likewise with latching pieces extending from the tips of the arm parts in the other direction orthogonal to the longitudinal direction of the arm parts.

3. The electric connector according to claim 2, wherein on the latching parts with release fingers, projections that serve as rocking fulcrums are provided in the proximity of the boundary between the release fingers and the latching pieces.

4. The electric connector according to claim 1, wherein the contact terminal comprises a contacting portion at both ends, and are so installed to the terminal attachment part that one contacting portion is positioned at the terminal attachment part and the other contacting portion is positioned beyond the supporting base, between the pair of arm parts.

5. The electric connector according to claim 1, wherein the terminal attachment part is covered by a shield cover that has a plug insertion mouth at one end.
